(19) United States
(12) Patent Application Publication
(10) Pub. No.: US 2011/0029953 A1
(43) Pub. Date: Feb. 3, 2011

(54) System and Method for Scalable Handling of Debug Information

(76) Inventors: Xavier Pouyollon, Sait Nolff (FR); Philippe Maisonneuve, Arradon (FR); Felix Burton, San Mateo, CA (US); Maarten Koning, Bloomfield (CA)

Correspondence Address: FAY KAPLUN & MARCIN, LLP, 150 BROADWAY, SUITE 702, NEW YORK, NY, 10038, US

(21) Appl. No.: 12/510,410

(22) Filed: Jul. 28, 2009

(51) Int. Cl. G06F 9/44

(52) U.S. Cl. 717/124

(57) ABSTRACT

Described herein are systems and tools for scalable handling of debug information. The system includes a memory storing an application, and a processor executing a set of instructions operable to generate a plurality of subsets from the application, produce a linkable file for each of the subsets, each linkable file including debug information for the corresponding subset, create a path from the application to the linkable files based on linked information, and load one of the linkable files for a selected subset. The debugging tool includes a removing means removing debug information from an application, a generating means generating a plurality of subsets within the application, a producing means producing a linkable debug file for each of the subsets of the application, each linkable debug file including debug information for the corresponding subset, a relocating means relocating each of the subsets within the application based on linked information, and a loading means loading the linkable debug file for a selected subset in order to debug the subset.

### BACKGROUND

The ability to build, debug, and deploy software programs onto a target device is critical to software development. Debugging often involves monitoring variables, parameters, and/or resources used in a software program. One conventional method of monitoring involves inserting print statements within the program's code and performing a diagnostics session. However, the conventional debugging methods described above are limited. Traditionally, a conventional debugger generates debug information in object files. Then, all of the object files are linked together to create one application image (e.g., an executable file, a shared library, a downloadable kernel module (“DKM”), etc.) containing all the code and data, in addition to the debug information. This results in very large images and, therefore, long link times and long load times for these debuggers.

Furthermore, conventional debuggers cannot handle extremely large, fully-linked debug information (e.g., debug information larger than 2 gigabytes). This is because of virtual memory limitations, but also because of non-scalable debug symbols management algorithms. Thus, the conventional debugging methods cannot be applied to handle debug information for large applications. Accordingly, a need exists for more scalable handling of these very large applications with debug information, while avoiding any extended link times and load times typically associated with the conventional debugging tools.

### SUMMARY OF THE INVENTION

A computer readable storage medium including a set of instructions executable by a processor, the set of instructions operable to generating a plurality of subsets from an application, producing a linkable file for each of the subsets, each linkable file including debug information for the corresponding subset, creating a path from the application to the linkable files based on linked information, and loading one of the linkable files for a selected subset.

A system including a memory storing an application, and a processor executing a set of instructions, the set of instructions being operable to generating a plurality of subsets from the application, producing a linkable file for each of the subsets, each linkable file including debug information for the corresponding subset, creating a path from the application to the linkable files based on linked information, and loading one of the linkable files for a selected subset.

A debugging tool including a removing means removing debug information from an application, a generating means generating a plurality of subsets within the application, a producing means producing a linkable debug file for each of the subsets of the application, each linkable debug file including debug information for the corresponding subset, a relocating means relocating each of the subsets within the application based on linked information, and a loading means loading the linkable debug file for a selected subset in order to debug the subset.

### BRIEF DESCRIPTION OF THE DRAWINGS

FIG. 1 shows an exemplary embodiment of a system for scalable handling of debug information according to the exemplary embodiments of the present invention.

FIG. 2 shows an exemplary embodiment of a method for scalable handling of debug information according to the exemplary embodiments of the present invention.

FIG. 3 shows an example of symbol location in an exemplary subset and a full application image according to the exemplary embodiments of the present invention.

FIG. 4 shows an exemplary screenshot of the full application image according to the exemplary embodiments of the present invention.

FIG. 5 shows an exemplary screenshot of a part of the debug information loaded upon user demand according to the exemplary embodiments of the present invention.

FIG. 6 shows an exemplary screenshot incorporating the use of breakpoints within the assembly code according to the exemplary embodiments of the present invention

### DETAILED DESCRIPTION

The exemplary embodiments of the present invention may be further understood with reference to the following description and the appended drawings, wherein like elements are referred to with the same reference numerals. The present invention relates to scalable handling of debug information. Specifically, the exemplary embodiments of the present invention relate to systems and methods for debugging very large executable applications. For example, a large executable application that may be too large for a conventional debugger to manage may be managed in the exemplary embodiments by loading debug information from constituting object files on demand. In other words, the exemplary embodiments allow for faster and more scalable handling of very large applications with debug information. Furthermore, these exemplary embodiments may be operable on a large application both while building an image (e.g., an executable file, a shared library, a downloadable kernel module (“DKM”), etc.), and while an exemplary debugging tool (e.g., a debugger) reads debug information.

As will be described below, the exemplary embodiments of the present invention describe methods and systems to work around current limitations, such as virtual memory limitations, non-scalable algorithms, etc. Specifically, the exemplary methods and systems may load only the debug “parts” (e.g., subsets or sub-subsets) that are needed during various intervals. In other words, these exemplary methods and systems may generate a debug subset image having debugging information of a fully-linked image. It should be noted that a compiler system may be used to solve similar issues by keeping the debug information in a separate database. However, doing so may prevent the use of standardized debugging data format, such as DWARF and may require significant compiler system changes.

The exemplary embodiments will be described with reference to debugging methods performed on an application program, such as user code. However, those skilled in the art will understand that the exemplary embodiments of the present invention may be implemented as part of an operating system, or for any situation where a group of applications share memory spaces. According to the exemplary embodiments of the present invention, the term memory may include, but is not limited to, any computer readable storage medium that may be utilized by the application, such as, for example, RAM memory, disk memory, flash memory, bubble memory, any other volatile or non-volatile type of memory, etc. As will be described in greater detail below, the debugging may be performed on a target device by a host device. Alternatively, it should be noted that the debugging may be performed within the host device by the host device.

According to the exemplary embodiments of the present invention, a subset may be described as a part or a portion of a computer program within an application. For example, the application may be composed of several parts (e.g., a collection of sub-projects or files, such as .o object files). Accordingly, an entire application image may be a composition of a plurality of subsets. In addition, each of the subsets may be further divided into sub-subsets. Each of these subsets, or sub-subsets, may be linked and debugged individually in order to generate debug information specific to that subset, or sub-subset. The exemplary embodiments described herein allow for each of these subsets to be relocated prior to a final link of the application image. Thus, a user may partition the application into a number of partially linked files (e.g., subsets) that may be then used to link the application image and strip or remove the image from debug information. Furthermore, these partially linked files may also be used to build the “parts” with debug information and are pre-relocated to match the application image, thereby allowing for the parts to be manually or automatically loaded into a debugging tool when debug information is required.

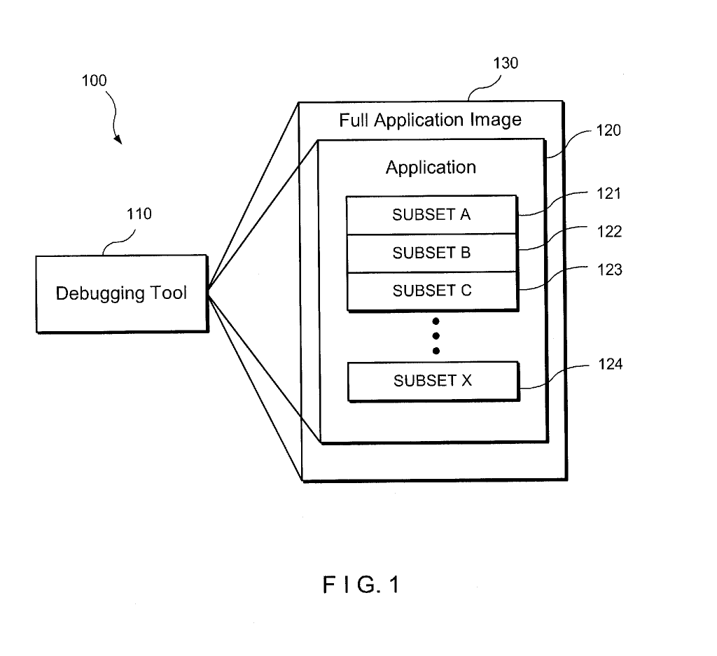

FIG. 1 shows an exemplary embodiment of a system 100 for scalable handling of debug information according to the exemplary embodiments of the present invention. The system 100 may include a debugging tool 110 capable of performing scalable handling of debug information of code being executed in an application 120, such as, for example an executable file, a shared library, a kernel. The application 120 may be included within a full application image 130.

It should be noted that the software application 120 may be created on a host-computing device and executed on a target device. This type of development is typical for embedded devices. An embedded device is any device that includes a processor or microcontroller that executes application 120 to carry out desired functions. Normally, an embedded device has fewer resources than a general-purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc. The exemplary embodiments of the present invention will be described with reference to a debugging tool for such embedded devices. However, those skilled in the art will understand that the present invention may be implemented in, for example, a debugging tool for software executing on any type of device.

The application 120 may be written in any programming language (e.g., C/C++, Java, Assembly language, etc.), and may be divided into any number of smaller parts, such as subset A 121, subset B 122, subset C 123, subset X 124, etc. Each of these subsets 121-124 may be executable code defined by a sequence of instructions extending from an initial memory addresses (e.g., a text start address, a data start address, a block started by symbol (“BSS”) start address, etc.) to a final memory address. Accordingly, the subsets 121-124 may include linker script that denote where the text, data, and BSS sections fit into the application 120. Furthermore, tool command language (“TCL”) scripts and compiling tools may be utilized on the subsets 121-124 in order to generate symbols of the part to be debugged. These symbols may then be associated with DATA or BSS symbols of the application 120 in order to relocate each of the subsets 121-124. It should be noted that while the system 100 illustrated in FIG. 1 includes four subsets 121-124, these components are merely for illustrative purposes. Accordingly, any number of the subsets and sub-subsets may be included within the exemplary system 100.

The debugging tool 110 may serve to generate a debug subset image having the debug information of the fully-linked application image 130 without the debug information actually being in the full application image 130. Therefore, the debugging tool 110 may debug a very large application, such as application 120, by loading the debug information from the constituting subsets 121-124 on demand. According to the exemplary embodiments of the present invention, the debugging tool 110 may take in entry the full executable image 130 of the application 120, wherein this image 130 may be stripped of any debug information. The debugging tool 110 may then take in entry each of the relocatable subsets 121-124 to debug, wherein these subsets 121-124 can each be a partial link.

As noted above, each of these subsets 121-124 may include their respective debug information. The debugging tool 110 may then produce a fully linked debugged object file (e.g., an executable and linkable format “ELF” file) with debug information relocated from the respective debug information of the subsets 121-124. Therefore, each of these respective “debug informations” may be located into its proper place within the full image 130. Finally, the debugging tool 110 may read each of the fully linked debugged object files and individually relocate each of the fully linked debug subsets 121-124 to match their respective location in the application 120. The loading of the subsets 121-124 may be performed upon a user command, or alternatively, may be performed automatically by the debugging tool 110. Thus, the exemplary system 100 may avoid the need to read debug information from the application image 130.

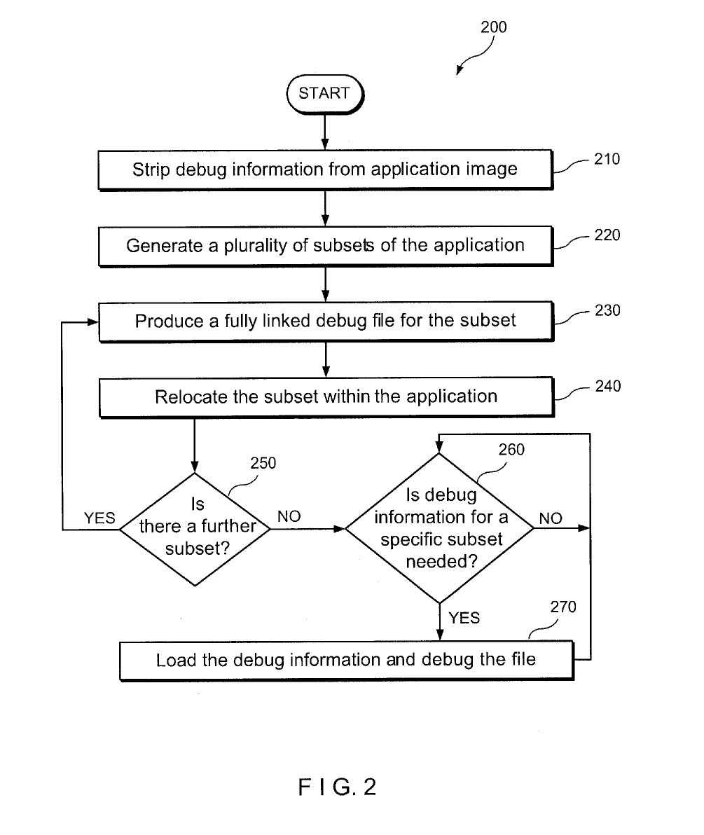

FIG. 2 shows an exemplary embodiment of a method 200 for scalable handling of debug information according to the exemplary embodiments of the present invention. Specifically, the method 200 may allow for the debugging tool 110, as well as a user, to debug only a subset (e.g., one of the subsets 121-124) of an entire application (e.g., the application 120). Therefore, as described above, the method 200 may allow for debugging of very large applications, while improving debug information load time and application link time. Accordingly, the exemplary method 200 may translate to a significantly improved edit-compile-debug cycle.

In step 210, the method 200 may strip any debug information from the full application image 130 of the application 120. Accordingly, the full image 130 may have no debug information within it. Those skilled in the art will understand that this step does not necessarily mean that debug information is in the full application image 130 and then it is removed, it merely means that the full application image 130 may be a “stripped” image, i.e., it does not include debug information. As described above, the exemplary method 200 allows for the debugging of the subsets 121-124 of the application by loading the debug information on demand for the subsets 121-124. Furthermore, the application 120 may be linked without copying any debug information into the application image 130. Thus, at the completion of step 210, the system 100 has a fully executable image that includes no debug information.

In step 220, the method 200 may generate the plurality of subsets 121-124 of the application 120. As described above, the application 120 may be composed of several parts, such as a collection of object files (.o files) or sub-projects. The code for each of these parts (e.g., the code of the subsets 121-124) may be compiled with debug information into object files. For instance, each of these relocatable parts may be partially linked. A partial link may divide application 120 into logical parts creating blocks of text, data, and BSS. That is, various modules (or object files) that are part of the subset may be linked and the various memory locations may be identified in this step (e.g., text start, data start, BSS start, etc.). Thus, each subset 121-124 may be a logical part of the application 120 based on the partial linking.

Those of skill in the art will understand that the subsets 121-124 do not need to be partially linked. In such a case, a user could select the various modules that will make up a subset. However, in such a case, the grouping of the subset may not be logical and when the final linking is performed, the modules selected by the user for the subset may be moved all over the place (e.g., to disparate memory locations) resulting in increased link times. Thus, if the user selects not to use partially linked subsets, the user will have to change the final link command to compensate for the user-selected subsets.

It should be noted that the grouping of modules and/or objects may only be needed when the loading of debug information is performed manually, as this may help reduce the number of items that the user would have to load. However, if the loading is performed automatically, then it may be beneficial to keep the modules small (e.g., use the object files directly). In this latter case, the order in which objects are linked and the use of link command files may be deemed irrelevant. Accordingly, the debugging tool 110 may automatically load debug information directly from object files without having to perform partial links.

In step 230, the method 200 may produce a fully linked debug file (e.g., an ELF file) for a first part, such as subset 121. It should be noted that the term “linked” in not intended to exclude the case of linkable object files. Accordingly, object files, themselves, may be used as subsets any may not be linked to a specific address. Instead, these object files may be described as “linkable” object files.

The debugging tool 110 may run a linker script at build time on the subset 121 in order to generate the fully linked debug file having debug information specific to the subset 121. The linker script may be generated to find where each of the blocks of the subset 121 (e.g., text, data, BSS) fit within the full application image 130. The linker script may also convert common symbols of the relocatable subset 121. As described above, a TCL script and compiling tools (e.g., Diab tools) may be utilized to accomplish these tasks. However, those of skill in the art will understand that the present invention is not limited to these types of scripts/tools. Other scripts/tools that perform equivalent functions may also be used. Thus, in this step, the symbols for the full application image 130 and the subset 121 are generated. Using this information, the debugging tool 110 may then compute a text start address, a data start address, and a BSS start address for the subset 121 in the full application image 130.

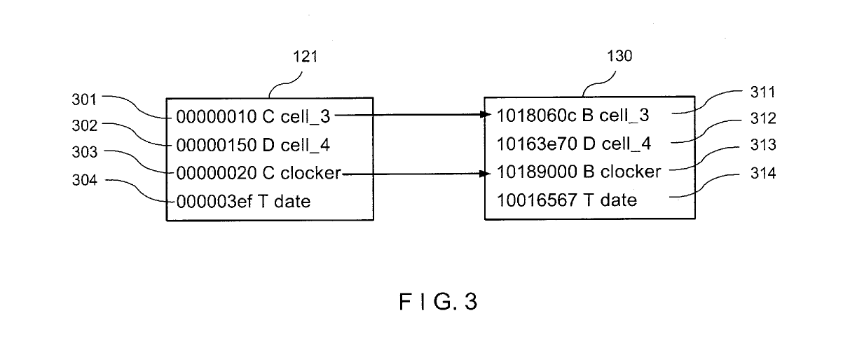

As described above, the partially linked subset 121 may include the memory locations of the various sections (e.g., text, data, BSS, etc.). The locations of these sections in the full application image 130 are also known, and thus an offset can be computed. FIG. 3 shows an example of symbol location in the subset 121 and the full application image 130 according to the exemplary embodiments of the present invention. Thus, for the text section 314 having an address of 0x10016567 corresponding to the text section 304 having address of 0x3ef, the offset may be computable as follows: 0x10016567−0x3ef=0x10016178. Similarly, for data section 312 and corresponding data section 302, the offset may be computed as follows: 0x10163e70−0x150=0x10163d20. Those of skill in the art will understand that once the offset is determined for each of the sections, the offset will be the same for all similar sections if the subset 121 is partially linked.

In contrast, the offset will not work for common symbols and the original if each common symbol in the full application image 130 needs to be retrieved. Thus, in the example illustrated in FIG. 3, the commons 311 and 313 corresponding to the commons 301 and 303 are retrieved. Once the common symbols are retrieved, they can be relocated to BSS symbols. That is, the commons in the subset 121 may be relocated to BSS symbols.

Thus, at the end of step 230, a fully linked file corresponding to the subset 121 has been created. As described above, the fully linked file may be an ELF file, or any other format selected by the developer. The fully linked file will include all of the debug information for the subset 121, but is not part of the full application image 130, and therefore does not add to the footprint of the full application image 130.

In step 240, the method 200 may relocate the current subset (e.g., subset 121) within the application 120. The debugging tool 110 may relocate the current subset 121 to match a location within the application 120 rather than read the debug information from the full application image 130. Specifically, the debugging tool 110 creates a path to the fully linked subset 121 with the debug information. Thus, the debugging tool 110 has built the subset 121 with debug information that is relocated to match the application image 130 and may be subsequently loaded into the debugging tool 110 when debug information is needed.

In step 250, the method 200 may determine whether there is a further subset (e.g., subset 122) within the application 120. If there is a further subset, such as subset 122, then the method 200 may return to step 230 and repeat the process to produce a fully linked debug file of the subset 122 and relocate the subset 122 within the application 120. If there are no further subsets, then the method 200 may advance to step 260.

In step 260, the method 200 may determine whether debug information for a specific subset is needed. As noted above, this determination may be made by a user of the debugging tool 110 or, alternatively, automatically by the debugging tool 110, itself. If there is need for such debug information for a specific subset, then the method 200 may advance to step 270 to load the debug information file. If there is no need for debug information, then the method 200 may continue to loop until the user needs to debug information.

In step 270, the method 200 may load the debug information file of the current subset 121 and debug the file. For example, it may have been determined in step 260 that the subset 121 is needed. Therefore, either on demand by the user or automatically, the debugging tool 110 may load this fully linked debug information file in order to debug the associated subset 121. As described above, the user by selecting a subset (e.g., subset 121) accesses a path to the fully linked file for the subset including the debug information. Thus, only when the user, or the debugging tool 110, wants to debug a specific part (e.g., subset 121), the debugging tool 110 will load the debug information file for just that part and only debug with that file. Once the debug information file has been loaded and debugged, the method 200 may return to step 260 in order to determine whether further debug information for a different subset is needed.

It should be noted that, in addition to the steps 210-270 performed by the exemplary method 200, alternative embodiments may include further steps, such as, for example: unloading at least one of the subsets when one subset does not fit into a memory of a debugging tool; unloading at least one of the subsets when the subset is not needed by the debugging tool; and automatically loading at least one of the subsets when needed by a debugging tool. The “unloading” of the subsets may also be described as “unlocking” of the subsets. Furthermore, an example of when an automatically loaded subset is needed may be when stepping into a function.

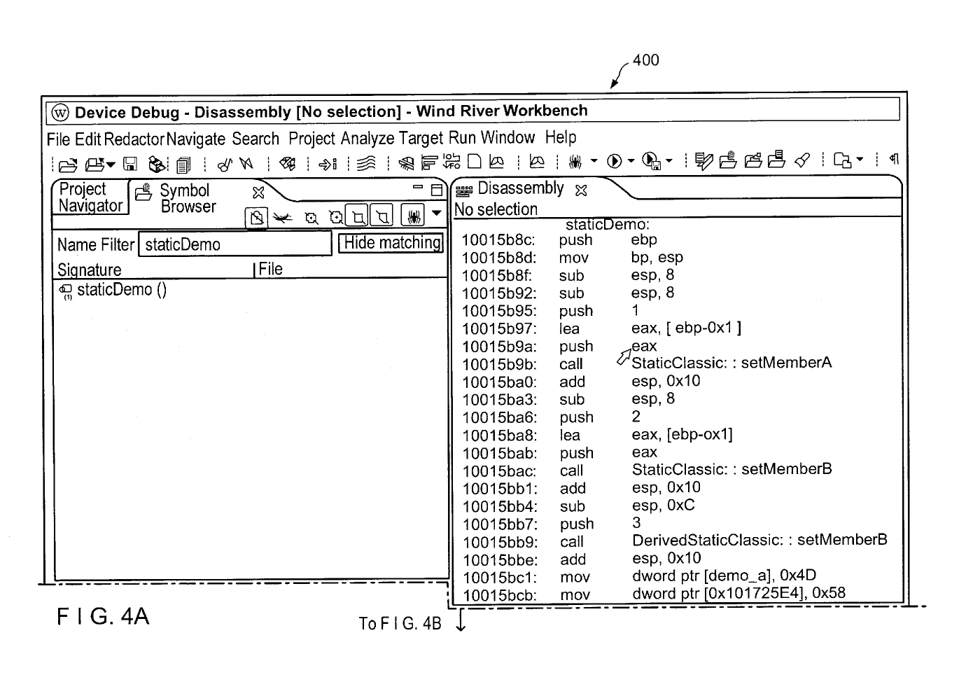

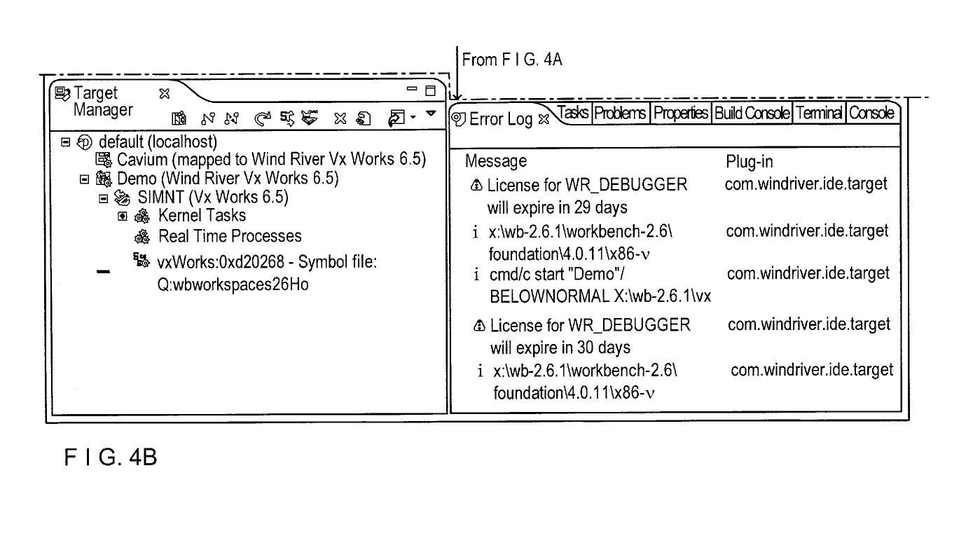

FIG. 4 shows an exemplary screenshot 400 of the full application image 130 according to the exemplary embodiments of the present invention. Accordingly, the screenshot 400 may display the assembly code of the full application image 130. As described above, the full application image 130 may boot (or load) with no debug information. Thus, as illustrated in screenshot 400, there is no debug information included and the code is displayed in the assembly mode.

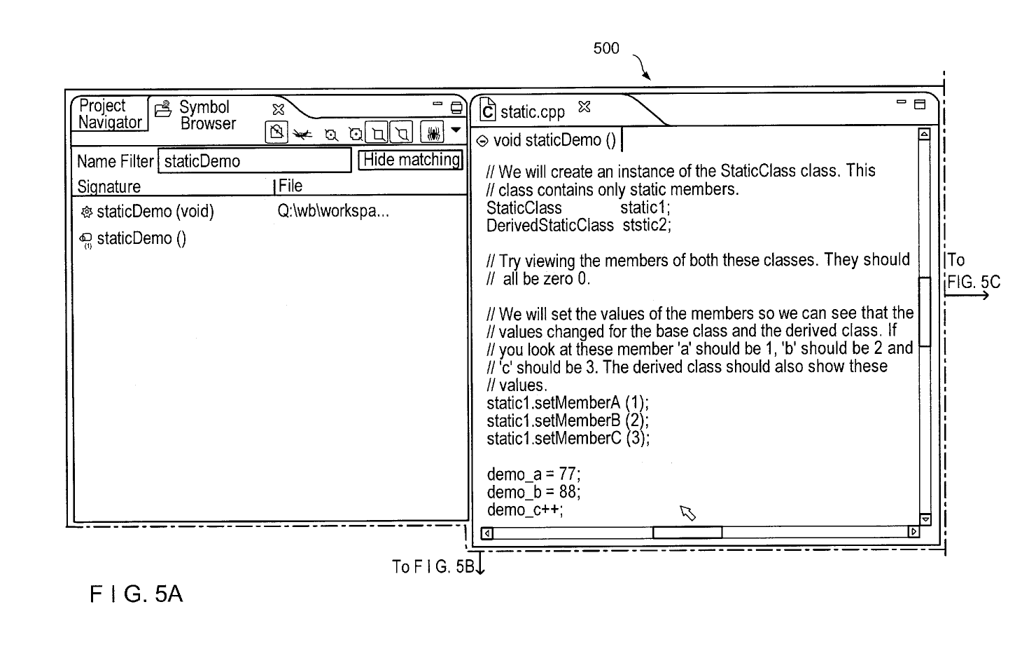

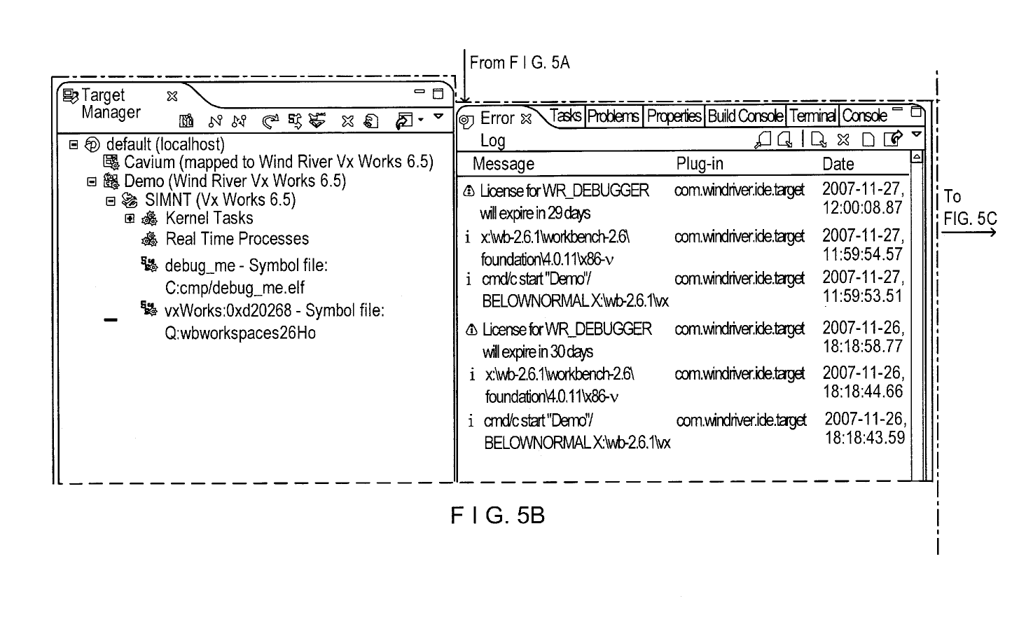

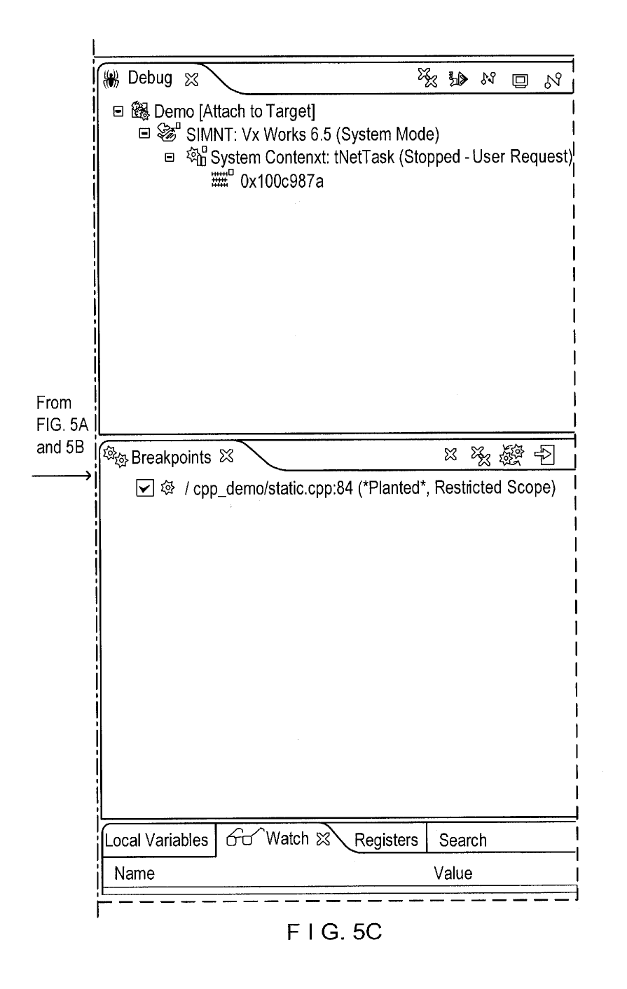

FIG. 5 shows an exemplary screenshot 500 of a part of the debug information loaded upon user demand according to the exemplary embodiments of the present invention. For example, the exemplary method 200 described above may allow for a return to source code of the application 120. In addition, the method 200 may allow for breakpoints to be added to the source code. Once returned to the C language source code of the application 120, the method 200 may then determine whether debug information for a specific subset is needed.

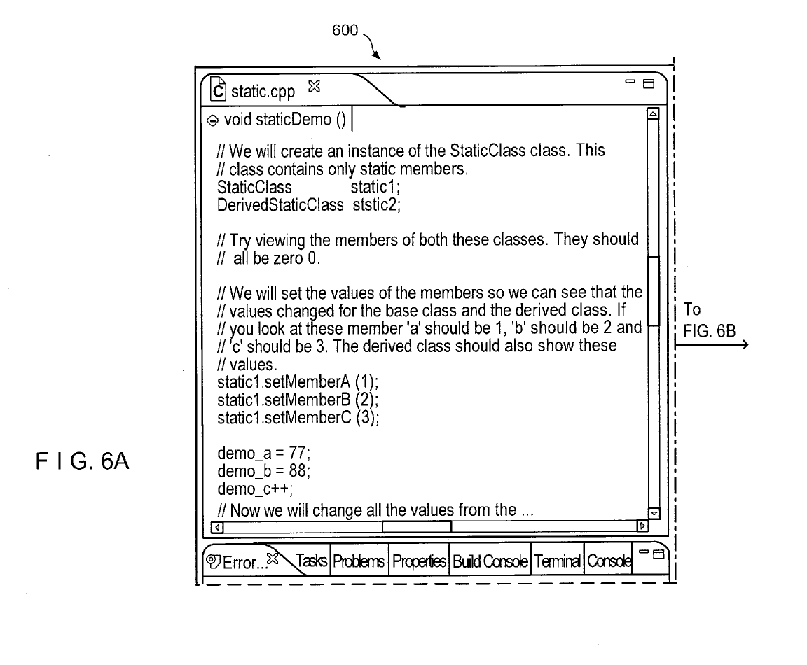

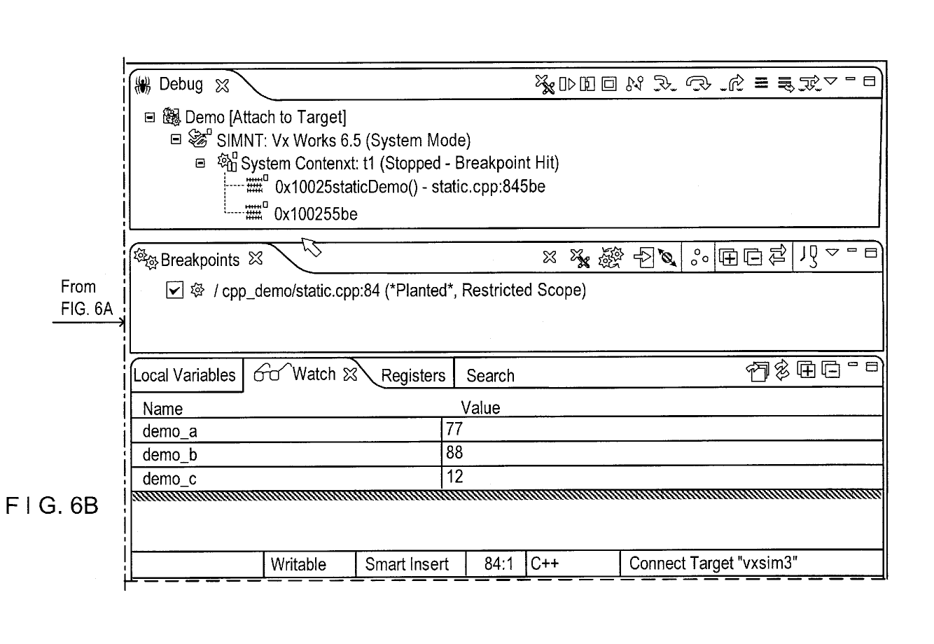

FIG. 6 shows an exemplary screenshot 600 incorporating the use of breakpoints within the assembly code according to the exemplary embodiments of the present invention. The information within the screenshot 600 allows the developer to create and adjust breakpoints within the source code, as well as monitor the variables. As described above, as the breakpoints are hit, the C language source code return may be available. Furthermore, the screenshot 600 may assure the developer that the run control is working properly.

It should be noted that the exemplary debugging tool 110 may include software development tools (e.g., such as Wind River Workbench, etc.) that may be used by the developer to create modify, and debug software programs such as the application 120. The debugging tool 110 may comprise a software suite that includes any number of individual software development programs, such as a compiler, a debugger, an operating system configurator, a source code analyzer, a text editor, etc. These individual programs may either be run independently of a running application or within a main development program.

Furthermore, those skilled in the art will also understand that the above described exemplary embodiments may be implemented in any number of manners, including, as a separate software module, as a combination of hardware and software, etc. For example, the debugging tool 110 may be a program containing lines of code stored in any type of computer-readable storage medium that, when compiled, may be executed by a processor.

According to the exemplary embodiments, the present invention may allow for a third party (e.g., a contractor) to be provided with a stripped full image of a product, as well as selectively providing them with only the debug parts (e.g., subsets) in which the third party is authorized to receive. In other words, this embodiment may offer protection over sensitive source code by limiting the portions of an application that are made available to third parties.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A computer readable storage medium including a set of instructions executable by a processor, the set of instructions operable to:
generating a plurality of subsets from an application;
producing a linkable file for each of the subsets, each linkable file including debug information for the corresponding subset;
creating a path from the application to the linkable files based on linked information; and
loading one of the linkable files for a selected subset.

2. The computer readable storage medium of claim 1, wherein an image of the application does not include debug information.

3. The computer readable storage medium of claim 1, wherein the linkable files are in an executable and linkable format (“ELF”).

4. The computer readable storage medium of claim 1, wherein the generating includes partially linking modules of the subset.

5. The computer readable storage medium of claim 1, wherein the producing includes determining memory offsets for sections or symbols.

6. The computer readable storage medium of claim 5, wherein the sections include at least one of text sections, data sections, and block started by symbol (“BSS”) sections.

7. The computer readable storage medium of claim 1, wherein the producing includes converting common symbols to memory addresses.

8. The computer readable storage medium of claim 1, wherein the set of instructions are further operable to:
displaying debug information for the subset when the corresponding linkable file is loaded.

9. The computer readable storage medium of claim 8, wherein the set of instructions are further operable to:
displaying source code for the subset when the corresponding linkable file is loaded.

10. The computer readable storage medium of claim 8, wherein the set of instructions are further operable to:
unloading at least one of the subsets when one of the at least one subset does not fit into a memory of a debugging tool and the at least one subset is not needed by the debugging tool.

11. The computer readable storage medium of claim 8, wherein the set of instructions are further operable to:
automatically loading at least one of the subsets when needed by a debugging tool.

12. A system, comprising:
a memory storing an application; and
a processor executing a set of instructions, the set of instructions being operable to:
generate a plurality of subsets from the application;
produce a linkable file for each of the subsets, each linkable file including debug information for the corresponding subset;
create a path from the application to the linkable files based on linked information; and
load one of the linkable files for a selected subset.

13. The system of claim 12, wherein an image of the application does not include debug information.

14. The system of claim 12, wherein the linkable files are in an executable and linkable format (“ELF”).

15. The system of claim 12, wherein the generating includes partially linking modules of the subset.

16. The system of claim 12, wherein the producing includes determining memory offsets for sections or symbols.

17. The system of claim 16, wherein the sections include at least one of text sections, data sections, and block started by symbol (“BSS”) sections.

18. The system of claim 12, wherein the producing includes converting common symbols to memory addresses.

19. The system of claim 12, wherein the set of instructions are further operable to:
displaying debug information for the subset when the corresponding linkable file is loaded.

20. The system of claim 19, wherein the set of instructions are further operable to:
displaying source code for the subset when the corresponding linkable file is loaded.

21. The system of claim 12, wherein the set of instructions are further operable to:
unloading at least one of the subsets when one of the at least one subset does not fit into a memory of a debugging tool and the at least one subset is not needed by the debugging tool.

22. The system of claim 12, wherein the set of instructions are further operable to:
automatically loading at least one of the subsets when needed by a debugging tool.

23. A debugging tool, comprising:
a removing means removing debug information from an application;
a generating means generating a plurality of subsets within the application;
a producing means producing a linkable debug file for each of the subsets of the application, each linkable debug file including debug information for the corresponding subset;
a relocating means relocating each of the subsets within the application based on linked information; and
a loading means loading the linkable debug file for a selected subset in order to debug the subset.
